(19) United States
(12) Patent Application Publication
(10) Pub. No.: US 2019/0244136 A1
(43) Pub. Date: Aug. 8, 2019

(54) INTER-SENSOR LEARNING

(71) Applicant: GM Global Technology Operations LLC, Detroit, MI (US)

(72) Inventors: Yasen Hu, Warren, MI (US); Shuqing Zeng, Sterling Heights, MI (US); Wei Tong, Troy, MI (US); Mohannad Murad, Troy, MI (US); Gregg R. Kittinger, Oakland Township, MI (US); David R. Petrucci, Warren, MI (US)

(21) Appl. No.: 15/888,322

(22) Filed: Feb. 5, 2018

(51) Int. Cl. G06N 99/00; G05D 1/02; G05D 1/00

(52) U.S. Cl. CPC G06N 99/005; G05D 1/0088; G05D 1/0255; G05D 1/0238

(57) ABSTRACT

A system and method to perform inter-sensor learning obtains a detection of a target based on a first sensor. The method also includes determining whether a second sensor with an overlapping detection range with the first sensor also detects the target, and performing learning to update a detection algorithm used with the second sensor based on the second sensor failing to detect the target.

### INTRODUCTION

The subject disclosure relates to inter-sensor learning.

Vehicles (e.g., automobiles, trucks, constructions vehicles, farm equipment) increasingly include sensors that obtain information about the vehicle and its environment. An exemplary type of sensor is a camera that obtains images. Multiple cameras may be arranged to obtain a 360 degree view around the perimeter of the vehicle, for example. Another exemplary type of sensor is an audio detector or microphone that obtains sound (i.e., audio signals) external to the vehicle. Additional exemplary sensors include a radio detection and ranging (radar) system and a light detection and ranging (lidar) system. The information obtained by the sensors may augment or automate vehicle systems. Exemplary vehicle systems include collision avoidance, adaptive cruise control, and autonomous driving systems. While the sensors may provide information individually, information from the sensors may also be considered together according to a scheme referred to as sensor fusion. In either case, the information from one sensor may indicate an issue with the detection algorithm of another sensor. Accordingly, it is desirable to provide inter-sensor learning.

### SUMMARY

In one exemplary embodiment, a method of performing inter-sensor learning includes obtaining a detection of a target based on a first sensor. The method also includes determining whether a second sensor with an overlapping detection range with the first sensor also detects the target, and performing learning to update a detection algorithm used with the second sensor based on the second sensor failing to detect the target.

In addition to one or more of the features described herein, the performing the learning is offline.

In addition to one or more of the features described herein, the method also includes performing online learning to reduce a threshold of detection by the second sensor prior to the performing the learning offline.

In addition to one or more of the features described herein, the method also includes logging data from the first sensor and the second sensor to execute the performing the learning offline based on the performing online learning failing to cause detection of the target by the second sensor.

In addition to one or more of the features described herein, the method also includes determining a cause of the second sensor failing to detect the target and performing the learning based on determining that the cause is based on the detection algorithm.

In addition to one or more of the features described herein, the performing the learning includes a deep learning.

In addition to one or more of the features described herein, the obtaining the detection of the target based on the first sensor includes a microphone detecting the target.

In addition to one or more of the features described herein, the determining whether the second sensor also detects the target includes determining whether a camera also detects the target.

In addition to one or more of the features described herein, the obtaining the detection of the target based on the first sensor and the determining whether the second sensor also detects the target is based on the first sensor and the second sensor being disposed in a vehicle.

In addition to one or more of the features described herein, the method also includes augmenting or automating operation of the vehicle based on the detection of the target.

In another exemplary embodiment, a system to perform inter-sensor learning includes a first sensor. The first sensor is detects a target. The system also includes a second sensor. The second sensor has an overlapping detection range with the first sensor. The system further includes a processor to determine whether the second sensor also detects the target and perform learning to update a detection algorithm used with the second sensor based on the second sensor failing to detect the target.

In addition to one or more of the features described herein, the processor performs the learning is offline.

In addition to one or more of the features described herein, the processor performs online learning to reduce a threshold of detection by the second sensor prior to performing the learning offline.

In addition to one or more of the features described herein, the processor logs data from the first sensor and the second sensor to perform the learning offline based on the online learning failing to cause detection of the target by the second sensor.

In addition to one or more of the features described herein, the processor determines a cause of the second sensor failing to detect the target and perform the learning based on determining that the cause is based on the detection algorithm.

In addition to one or more of the features described herein, the learning includes deep learning.

In addition to one or more of the features described herein, the first sensor is a microphone.

In addition to one or more of the features described herein, the second sensor is a camera.

In addition to one or more of the features described herein, the first sensor and the second sensor are disposed in a vehicle.

In addition to one or more of the features described herein, the processor augments or automates operation of the vehicle based on the detection of the target.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 is a block diagram of a system to perform inter-sensor learning according to one or more embodiments;

FIG. 2 is an exemplary scenario used to explain inter-sensor learning according to one or more embodiments;

FIG. 3 is an exemplary process flow of a method of performing inter-sensor learning according to one or more embodiments;

FIG. 4 is a process flow of a method of performing offline learning based on the inter-sensor learning according to one or more embodiments;

FIG. 5 shows an exemplary process flow for re-training based on inter-sensor learning according to one or more embodiments; and

FIG. 6 illustrates an example of obtaining an element of the matrix output according to an exemplary embodiment.

### DETAILED DESCRIPTION

The following description is merely exemplary in nature and is not intended to limit the present disclosure, its application or uses. It should be understood that throughout the drawings, corresponding reference numerals indicate like or corresponding parts and features.

As previously noted, various sensors may be located in a vehicle to obtain information about vehicle operation or the environment around the vehicle. Some sensors (e.g., radar, camera, microphone) may be used to detect objects such as other vehicles, pedestrians, and the like in the vicinity of the vehicle. The detection may be performed by implementing a machine learning algorithm, for example. Each sensor may perform the detection individually. In some cases, sensor fusion may be performed to combine the detection information from two or more sensors. Sensor fusion requires that two or more sensors have the same or at least overlapping fields of view. This ensures that the two or more sensors are positioned to detect the same objects and, thus, detection by one sensor may be used to enhance detection by the other sensors. Whether sensor fusion is performed or not, embodiments described herein relate to using the common field of view of sensors to improve their detection algorithms.

Specifically, embodiments of the systems and methods detailed herein relate to inter-sensor learning. As described, the information from one sensor is used to fine tune the detection algorithm of another sensor. Assuming a common field of view, when one type of sensor indicates that an object has been detected while another type of sensor does not detect the object, a determination must first be made about why the discrepancy happened. In one case, the detection may be a false alarm. In another case, the object may not have been detectable within the detection range of the other type of sensor. For example, a microphone may detect an approaching motorcycle but, due to fog, the camera may not detect the same motorcycle. In yet another case, the other type of sensor may have to be retrained.

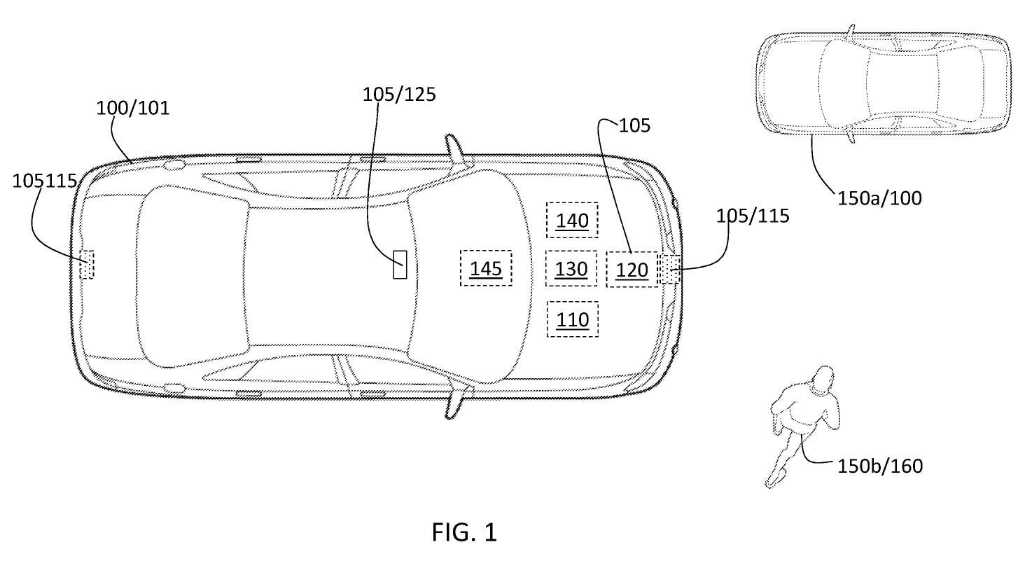

In accordance with an exemplary embodiment, FIG. 1 is a block diagram of a system to perform inter-sensor learning. The vehicle 100 shown in FIG. 1 is an automobile 101. For purposes of clarity, the vehicle 100 discussed as performing the inter-sensor learning will be referred to as an automobile 101. While three types of exemplary sensors 105 are shown in FIG. 1, any number of sensors 105 of any number of types may be arranged anywhere in the vehicle 100. Two cameras 115 are shown at each end of the vehicle 100, a microphone 125 is shown on the roof of the vehicle 100, and a radar system 120 is also shown. The sensors 105 may detect objects 150a, 150b (generally referred to as 150) around the vehicle 100. Exemplary objects 150 shown in FIG. 1 include another vehicle 100 and a pedestrian 160. The detection of these objects 150 along with their location and heading may prompt an alert to the driver of the automobile 101 or automated action by the automobile 101.

Each of the sensors 105 provides data to a controller 110 which performs detection according to an exemplary architecture. As noted, the exemplary sensors 105 and detection architecture discussed with reference to FIG. 1 for explanatory purposes are not intended to limit the number and types of sensors 105 of the automobile 101 or the one or more processors that may implement the learning. For example, each of the sensors 105 may including the processing capability discussed with reference to the controller 110 in order to perform detection individually. According to additional alternate embodiments, a combination of processors may perform the detection and learning discussed herein.

As previously noted, the controller 110 performs detection based on data from each of the sensors 105, according to the exemplary architecture. The controller 110 includes processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality. The controller 110 may communicate with an electronic control unit (ECU) 130 that communicates with various vehicle systems 140 or may directly control the vehicle systems 140 based on the detection information obtained from the sensors 105. The controller 110 may also communicate with an infotainment system 145 or other system that facilitates the display of messages to the driver of the automobile 101.

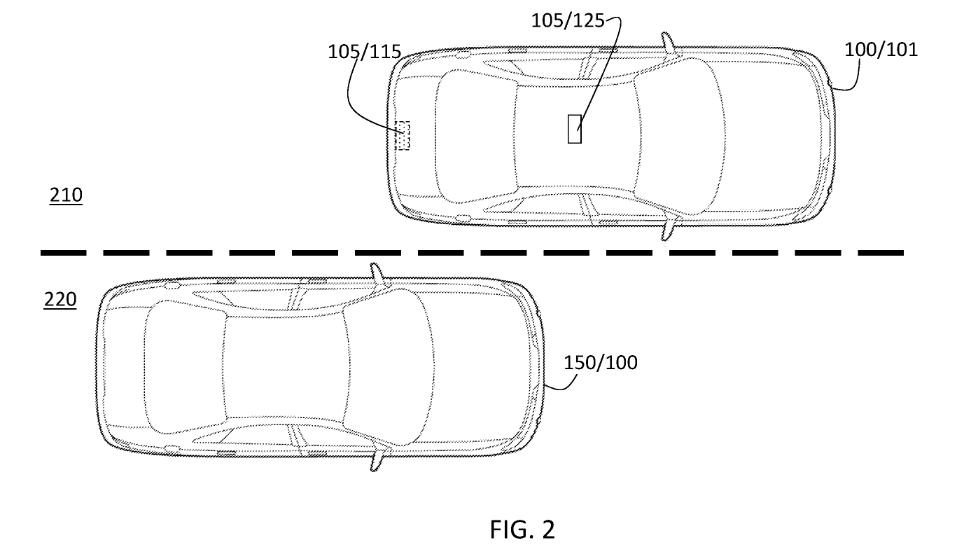

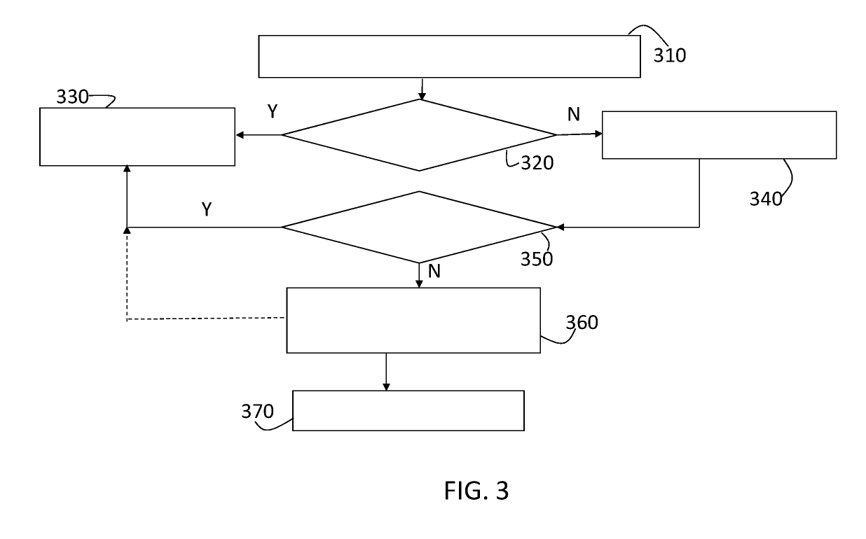

FIG. 2 is an exemplary scenario used to explain inter-sensor learning according to one or more embodiments. As shown, an automobile 101 includes a camera 115 and a microphone 125. The automobile 101 is travelling in lane 210 while an object 150, another vehicle 100, is travelling in the same direction in an adjacent lane 220. According to the positions shown in FIG. 2, movement by the automobile 101 from lane 210 to the adjacent lane 220 may cause a collision with the object 150. The processes involved in inter-sensor learning based on this scenario are discussed with reference to FIG. 3.

FIG. 3 is an exemplary process flow of a method of performing inter-sensor learning according to one or more embodiments. The exemplary scenario depicted in FIG. 2 is used to discuss the processes. Thus, the example involves only two sensors 105, a camera 115 and microphone 125. However, the processes discussed apply, as well, to any number of sensors 105 in any number of arrangements. Specifically, the scenario shown in FIG. 2 involves an attempted lane change from lane 210 to lane 220 with an object 150, the other vehicle 100, positioned such that the lane change would result in a collision.

At block 310, obtaining detection based on the microphone 125 refers to the fact that data collected with the microphone 125 indicates the object 150, the other vehicle 100, in lane 220. The detection may be performed by the controller 110 according to an exemplary embodiment. In the scenario shown in FIG. 2, the microphone 125 may pick up the engine sound of the object 150, for example.

At block 320, a check is done of whether the camera 115 also sees the object 150. Specifically, processing of images obtained by the camera 115 at the controller 110 may be used to determine if the object 150 is detected by the camera 115. If the camera 115 does see the object 150, then augmenting or automating an action, at block 330, refers to alerting the driver to the presence of the object 150 or automatically preventing the lane change. The alert to the driver may be provided on a display of the infotainment system 145 or, alternately or additionally, via other visual (e.g., lights) or audible indicators. If the camera 115 does not also detect the object 150 that was detected by the microphone 125, then performing online learning, at block 340, refers to real-time adjustments to the detection algorithm associated with the camera 115 data. For example, the detection threshold may be reduced by a specified amount.

At block 350, another check is done of whether the camera 115 detects the object 150 that the microphone 125 detected. This check determines whether the online learning, at block 340, changed the result of the check at block 320. If the online learning, at block 340, did change the result such that the check at block 350 determines that the camera 115 detects the object 150, then the process of augmenting or automating the action is performed at block 330.

If the online learning, at block 340, did not change the result such that the check at block 350 indicates that the camera 115 still does not detect the object 150, then logging the current scenario, at block 360, refers to recording the data from the camera 115 and the microphone 125 along with timestamps. The timestamps facilitate analyzing data from different sensors 105 at corresponding times. Other information available to the controller 110 may also be recorded. Once the information is logged, at block 360, the process of augmenting or automating action, at block 330, may optionally be performed. That is, a default may be established for the situation in which both sensors 105 (e.g., camera 115 and microphone 125) do not detect the object 150 in their common field of detection, even after online learning, at block 340. This default may be to perform the augmentation or automation, at block 330, based only one sensor 105 or may be to perform no action unless both (or all) sensors 105 detect an object 150.

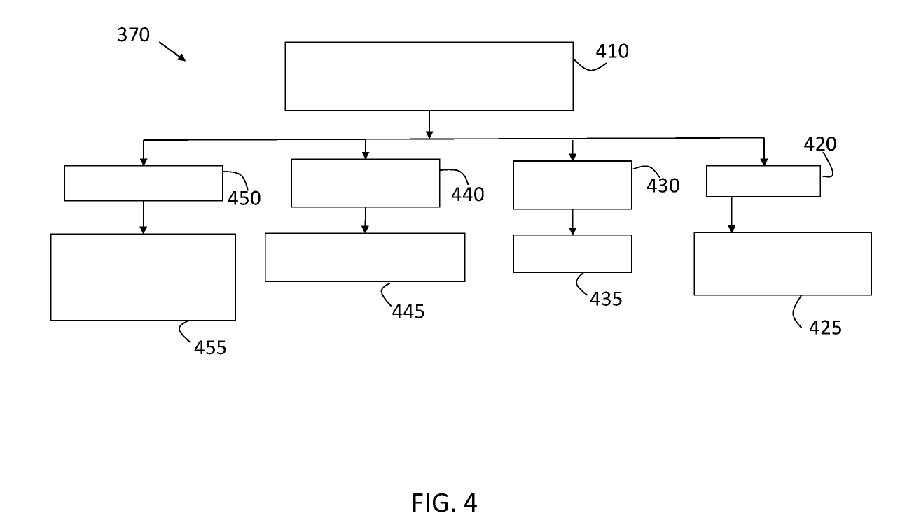

At block 370, the processes include performing offline analysis, which is detailed with reference to FIG. 4. The analysis may lead to a learning process for the detection algorithm of the camera 115. The learning may be deep learning, which is a form of machine learning that involves learning data representations rather than task-specific algorithms. The analysis, at block 370, of the information logged at block 360 may be performed by the controller 110 according to exemplary embodiments. According to alternate or additional embodiments, the analysis of the logged information may be performed by processing circuitry outside the automobile 101. For example, logs obtained from one or more vehicles 100, including the automobile 101, may be processed such that detection algorithms associated with each of those vehicles 100 may be updated.

While the scenario depicted in FIG. 2 and also discussed with reference to FIG. 3 involves only two sensors 105, the processes discussed above may be followed with multiple sensors. For example, the object 150 may be in the field of view of other sensors 105 that may or may not be part of a sensor fusion arrangement with the camera 115 and microphone 125. As previously noted, the processes discussed above require a common (i.e., at least overlapping) field of view among the sensors 105 involved. That is, the processes discussed with reference to FIG. 3 only apply to two or more sensors 105 that are expected to detect the same objects 150. For example, if the automobile 101 shown in FIG. 2 included a radar system 120 in the front of the vehicle 100, as shown in FIG. 1, the field of view of the radar system 120 would be completely different than the field of view of the camera 115 shown at the rear of the vehicle 100. Thus, detection of an object 150 by the radar system 120 would not trigger the processes shown in FIG. 3 with regard to the camera 115.

FIG. 4 is a process flow of a method of performing offline learning, at block 370 (FIG. 3), based on the inter-sensor learning according to one or more embodiments. At block 410, the processes include analyzing the log, recorded at block 360, to determine the cause of the failure to detect. In the exemplary case discussed with reference to FIG. 3, the failure refers to the failure to detect the object 150, the other vehicle 100, using the camera 115 even though the microphone 125 detected the object 150 and following the online learning, at block 340. As FIG. 4 indicates, the analysis at block 410 results in the determination of one of four conditions.

Based on the analysis at block 410, a false alarm indication, at block 420, refers to determining that the sensor 105 that resulted in the detection was wrong. In the exemplary case discussed with reference to FIG. 3, the analysis would indicate that the microphone 125 incorrectly detected an object 150. In this case, at block 425, analyzing the detecting sensor 105, the microphone 125, refers to using the same log of information to retrain the microphone 125 or increase the detection threshold, as needed. The processes shown in FIG. 4 may be re-used for the microphone 125.

Based on the analysis at block 410, an indication may be provided, at block 430, that the sensor 105 was fully blocked. In the exemplary case discussed with reference to FIG. 3, the analysis may indicate that the camera 115 view was fully occluded. This may be due to dirt on the lens, heavy fog, or the like. The analysis may rely on the images from the camera 115 as well as additional information such as weather information. In this case, no action may be taken with regard to the detection algorithm of the camera 115, at block 435, because the detection algorithm associated with the camera 115 is not at issue. Additionally, system architecture may be reconfigured (e.g. additional cameras 115 may be added) to address a blind spot identified by the analysis at block 370, for example.

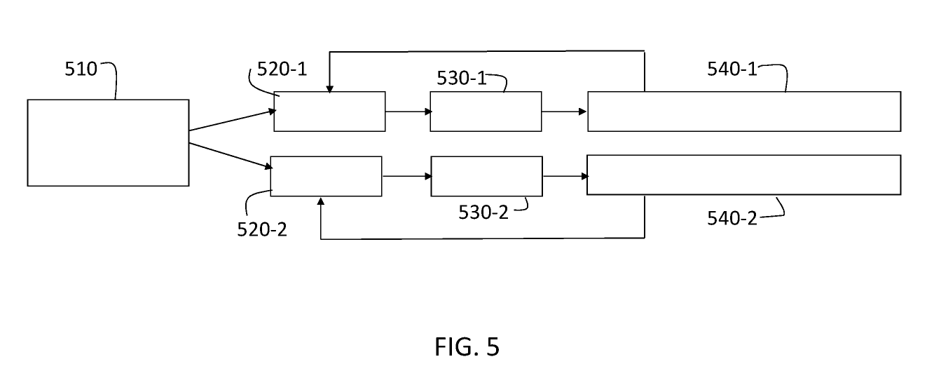

Based on the analysis at block 410, an indication may be provided, at block 440, that the sensor 105 was partially blocked. In the exemplary case discussed with reference to FIG. 3, the analysis may indicate that the camera 115 view was partially occluded due to another vehicle 100 being directly in front of the camera 115 (i.e., directly behind the automobile 101). Thus, only a small portion of the object 150, the vehicle in lane 220, may be visible in the field of view of the camera 115. In this case, adjusting the detection threshold, at block 445, may be performed to further reduce the threshold from the adjustment performed during the online training, at block 340. Alternately or additionally, the detection algorithm may be adjusted, as discussed with reference to FIG. 5.

Based on the analysis at block 410, an indication may be provided, at block 450, that re-training of the sensor 105 is needed. In the exemplary case discussed with reference to FIG. 3, this would mean there is no indication, at blocks 430 or 440, of partial or complete occlusion of the camera 115 and no indication, at block 420, that the detection by the microphone 125 was a false alarm. In this case, mining an example from the log and re-training the algorithm, at block 455, refers to obtaining the relevant data from the other sensor 105 (the microphone 125) and adjusting the detection algorithm of the camera 115. As previously noted, an exemplary re-training process is discussed with reference to FIG. 5.

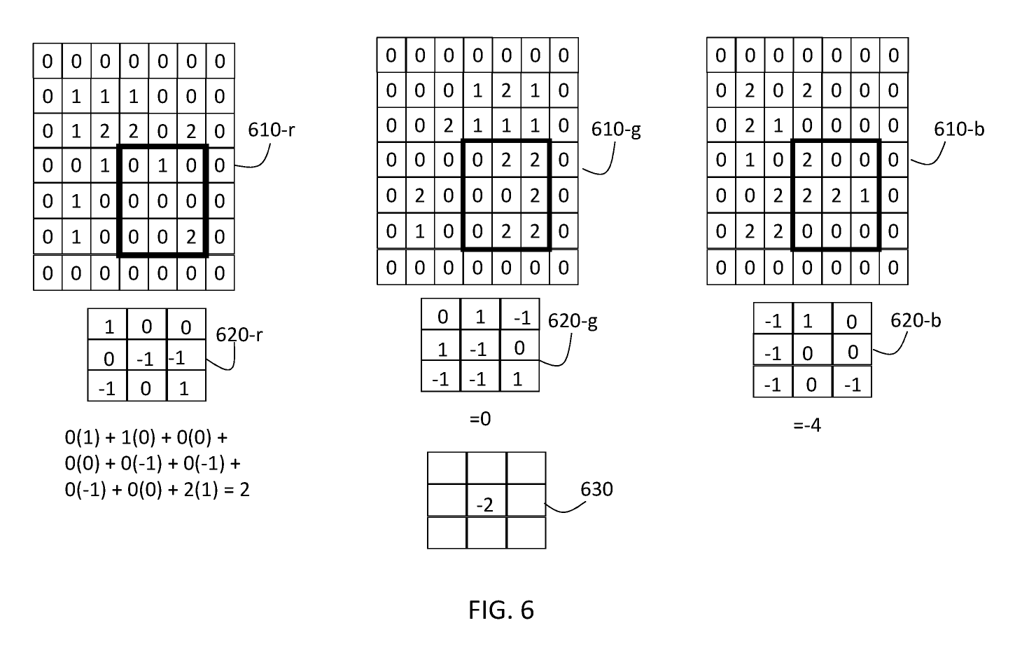

FIG. 5 shows an exemplary process flow for re-training based on inter-sensor learning according to one or more embodiments. Each of the logged images at block 360 may undergo the processes shown in FIG. 5. Obtaining an image, at block 510, may include obtaining three matrices according to an exemplary embodiment using red-green-blue (RGB) light intensity values to represent each image pixel. One matrix includes the intensity level of red color associated with each pixel, the second matrix includes the intensity level of green color associated with each pixel, and the third matrix includes the intensity level of blue color associated with each pixel. As FIG. 5 indicates, filter 1 and filter 2 are applied to the image at blocks 520-1 and 520-2, respectively, according to the example. Each filter is a set of three matrices, as discussed with reference to FIG. 6.

Producing output 1 and output 2, at blocks 530-1 and 530-2, respectively, refers to obtaining a dot product between each of the three matrices of the image and the corresponding one of the three matrices of each filter. When the image matrices have more elements than the filter matrices, multiple dot product values are obtained using a moving window scheme whereby the filter matrix operates on a portion of the corresponding image matrix at a time. The output matrices indicate classification (e.g., target (1) or no target (0)). This is further discussed with reference to FIG. 6.

The processes include comparing output 1, obtained at block 530-1, with ground truth, at block 540-1, and comparing output 2, obtained at block 530-2, with ground truth, at block 540-2. The comparing refers to comparing the classification indicated by output 1, at block 540-1, and the classification indicated by output 2, at block 540-2, with the classification indicated by the fused sensor 105, the microphone 125 in the example discussed herein. That is, according to the exemplary case, obtaining a detection based on the microphone 125, at block 310, refers to the classification obtained by processing data from the microphone 125 indicating a target (1).

If the comparisons, at blocks 540-1 and 540-2, show that the classifications obtained with the images and current filters match the classification obtained with the microphone 125, then the next logged image is processed according to FIG. 5. When the comparison, at block 540-1 or 540-2, shows that there is no match, then the corresponding filter (i.e., filter 1 if the comparison at block 540-1 indicates no match, filter 2 if the comparison at block 540-2 indicates no match) is adjusted. The process of iteratively adjusting filter values continues until the comparison indicates a match.

FIG. 6 illustrates an example of obtaining an element of the matrix output 1, at block 530-1, according to an exemplary embodiment. Matrices 610-r, 610-g, and 610-b correspond with an exemplary image obtained at block 510. As FIG. 6 indicates, the exemplary matrices 610-r, 610-g, 610-b are 7-by-7 matrices. A corresponding set of three filter matrices 620-r, 620-g, and 620-b are shown, as well. The filter matrices 620-r, 620-g, 620-b are 3-by-3 matrices. Thus, a dot product is obtained with each filter matrix 620-r, 620-g, or 620-b in nine different positions over the corresponding matrices 610-r, 610-g, 610-b. This results in nine dot product values in a three-by-three output matrix 630 associated with each set of filter matrices 620-r, 620-g, 620-b, as shown. Each set of filter matrices 620-r, 620-g, 620-b (i.e., corresponding to filter 1 and filter 2) may be associated with a particular object 150 to be detected (e.g., vehicle 100, pedestrian 160).

The dot product for the fifth position of the filter matrices 620-r, 620-g, and 620-b over the corresponding matrices 610-r, 610-g, and 610-b is indicated and the computation is shown for matrix 610-r and filter matrix 620-r. The fifth element of the output matrix 630 is the sum of the three dot products shown for the three filter matrices 620-r, 620-g, and 620-b (i.e., 2+0+(−4)=−2). Once the three dot products are obtained for each of the nine positions of the filter matrices 620-r, 620-g, and 620-b and the output matrix 630 is filled in, the output matrix 630 is used to obtain the classification (e.g., target (1) or no target (0)) based on additional processes. These additional processes include a known fully connected layer, in addition to the above-discussed convolution and pooling layers.

As previously noted, filter 1 may be associated with detection of a vehicle 100 (e.g., 150a, FIG. 1), for example, while filter 2 is associated with detection of a pedestrian 160. In the fully connected layer, each of the matrices, output 1 and output 2, is treated as a one-dimensional vector. Each element of the vector is weighted and summed. If the result of this sum associated with output 1 is greater than the result of the sum associated with output 2, for example, then the classification for a vehicle 100 may be 1 while the classification for a pedestrian 160 may be 0. This is because output 1 is obtained using filter 1, which is the set of filter matrices 620-r, 620-g, 620-b corresponding with a vehicle 100, while output 1 is obtained using filter 2, which is the set of filter matrices 620-r, 620-g, 620-b corresponding with a pedestrian 160.

As FIG. 5 indicates, filter 1 and filter 2 are both applied to each image obtained at block 510. Thus, two output matrices 630 are obtained, at blocks 530-1 and 530-2, based on two sets of filter matrices 620-r, 620-g, and 620-b being used to obtain dot products for the matrices 610-r, 610-g, and 610-b. As FIG. 5 also indicates, the classification indicated by each output matrix 630 is compared with the classification obtained with the microphone 125 for the same time stamp, at blocks 540-1 and 540-2. Based on the result of the comparison, one of filter 1 or filter 2 may be updated while the other is maintained. In the example, the classification for a vehicle 100, based on using filter 1, should be 1. Thus, if the comparison at block 540-1 indicates that a vehicle 100 was not detected, then filter 1 may be updated. On the other hand, the microphone 125 did not detect a pedestrian 160. Thus, if the comparison at block 540-2 indicates that a pedestrian 160 was not detected, then filter 2 need not be updated.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A method of performing inter-sensor learning, the method comprising:
obtaining a detection of a target based on a first sensor;
determining whether a second sensor with an overlapping detection range with the first sensor also detects the target; and
performing learning to update a detection algorithm used with the second sensor based on the second sensor failing to detect the target.

2. The method according to claim 1, wherein the performing the learning is offline.

3. The method according to claim 2, further comprising performing online learning to reduce a threshold of detection by the second sensor prior to the performing the learning offline.

4. The method according to claim 3, further comprising logging data from the first sensor and the second sensor to execute the performing the learning offline based on the performing online learning failing to cause detection of the target by the second sensor.

5. The method according to claim 1, further comprising determining a cause of the second sensor failing to detect the target and performing the learning based on determining that the cause is based on the detection algorithm.

6. The method according to claim 1, wherein the performing the learning includes a deep learning.

7. The method according to claim 1, wherein the obtaining the detection of the target based on the first sensor includes a microphone detecting the target.

8. The method according to claim 7, wherein the determining whether the second sensor also detects the target includes determining whether a camera also detects the target.

9. The method according to claim 1, wherein the obtaining the detection of the target based on the first sensor and the determining whether the second sensor also detects the target is based on the first sensor and the second sensor being disposed in a vehicle.

10. The method according to claim 9, further comprising augmenting or automating operation of the vehicle based on the detection of the target.

11. A system to perform inter-sensor learning, the system comprising:
a first sensor, wherein the first sensor is configured to detect a target;
a second sensor, wherein the second sensor has an overlapping detection range with the first sensor; and
a processor configured to determine whether the second sensor also detects the target and perform learning to update a detection algorithm used with the second sensor based on the second sensor failing to detect the target.

12. The system according to claim 11, wherein the processor is configured to perform the learning is offline.

13. The system according to claim 12, wherein the processor is further configured to perform online learning to reduce a threshold of detection by the second sensor prior to performing the learning offline.

14. The system according to claim 13, wherein the processor is further configured to log data from the first sensor and the second sensor to perform the learning offline based on the online learning failing to cause detection of the target by the second sensor.

15. The system according to claim 11, wherein the processor is further configured to determine a cause of the second sensor failing to detect the target and perform the learning based on determining that the cause is based on the detection algorithm.

16. The system according to claim 11, wherein the learning includes deep learning.

17. The system according to claim 11, wherein the first sensor is a microphone.

18. The system according to claim 17, wherein the second sensor is a camera.

19. The system according to claim 11, wherein the first sensor and the second sensor are disposed in a vehicle.

20. The system according to claim 19, wherein the processor is further configured to augment or automate operation of the vehicle based on the detection of the target.
